(19) United States
(12) Patent Application Publication
(10) Pub. No.: US 2005/0180676 A1
(43) Pub. Date: Aug. 18, 2005

(54) Faraday structured waveguide modulator

(75) Inventor: Sutherland Ellwood Jr., Clinton Corners, NY (US)

Correspondence Address: PANORAMA FLAT;C/O PATENT LAW OFFICES OF MICHAEL E. WOODS, 112 BARN ROAD, TIBURON, CA, 94920, US

(73) Assignee: Panorama FLAT Ltd., Perth (AU)

(21) Appl. No.: 10/811,782

(22) Filed: Mar. 29, 2004

Related U.S. Application Data
(60) Provisional application No. 60/544,591, filed on Feb. 12, 2004.

(51) Int. Cl. G02B 6/00

(52) U.S. Cl. 385/11

(57) ABSTRACT

Abstract of the Disclosure

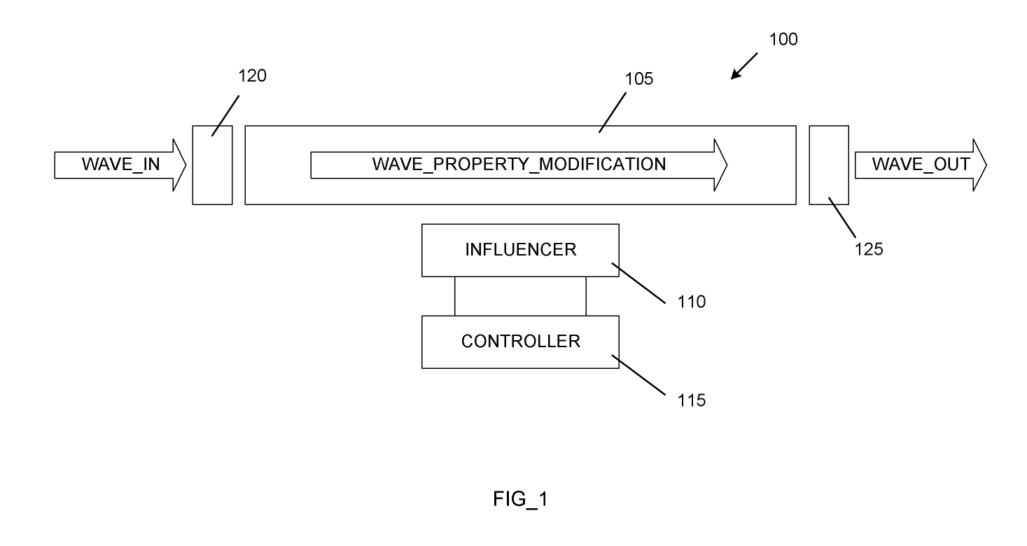

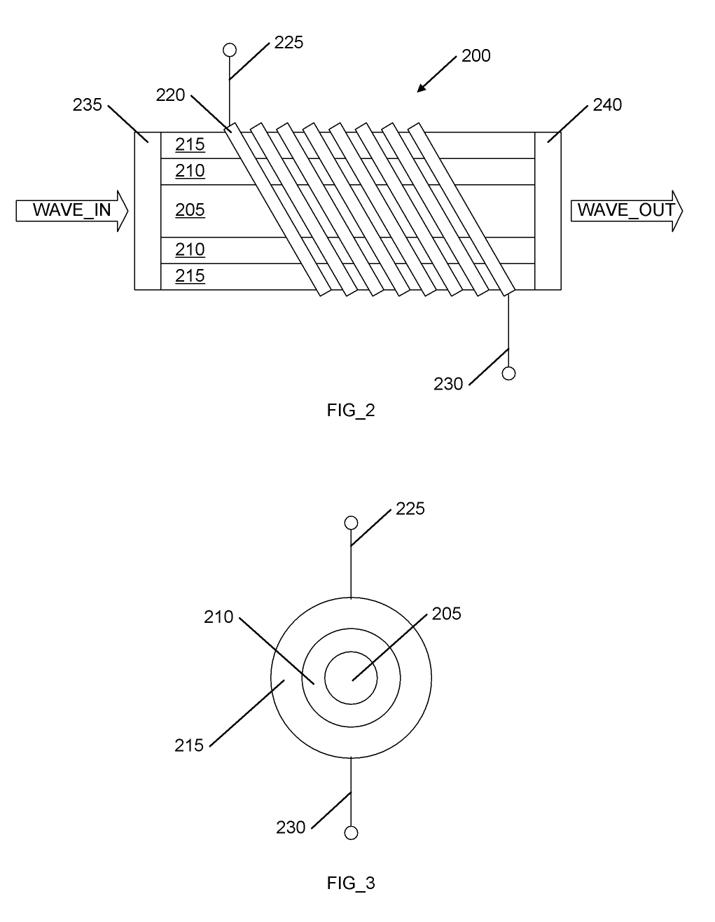

Disclosed is an apparatus and method for modulating radiation having one or more predetermined properties, the apparatus and method including a waveguide structure having a mechanism for controllably influencing the one or more predetermined properties to modulate an emitted intensity. A radiation wave intensity modulator includes a first element for producing a wave component from a radiation wave, the wave component having a polarization property wherein the polarization property is selected from one of an orthogonal set of polarizations; an optical transport for receiving the wave component; a transport influencer, operatively coupled to the optical transport, for affecting the polarization property of the wave component responsive to a control signal; and a second element for interacting with the affected wave component wherein an intensity of the wave component is varied responsive to the control signal. A radiation wave intensity modulating method, the method includes producing a wave component from a radiation wave, the wave component having a polarization property wherein the polarization property is selected from one of an orthogonal set of polarizations (e.g., one of a right hand circular polarization or a left hand circular polarization); receiving the wave component; affecting the polarization property of the wave component responsive to a control signal; and interacting with the affected wave component wherein an intensity of the wave component is varied responsive to the control signal.

### Detailed Description of the Invention

### CROSS REFERENCE TO RELATED APPLICATIONS

This Application claims priority from US Provisional Application 60/544,591 entitled "SYSTEM, METHOD, AND COMPUTER PROGRAM PRODUCT FOR MAGNETO-OPTIC DEVICE DISPLAY" filed on 12 February 2004, and is related to US Patent Application 10/812,294 entitled "FARADAY STRUCTURED WAVEGUIDE" and is related to US Patent Application 10/812,295 entitled "FARADAY STRUCTURED WAVEGUIDE DISPLAY" both filed on even date herewith and all expressly incorporated by reference for all purposes.

### BACKGROUND OF THE INVENTION

The present invention relates generally to a modulating waveguide structure for transmitting radiation having one or more predetermined properties, with the modulating waveguide structure having a mechanism for controllably influencing the one or more predetermined properties to vary an intensity of emitted radiation, and more specifically to an optical fiber with a predetermined Verdet profile for transmitting radiation having a particular polarization and an integrated structure for controllably altering the polarization of the radiation as it travels through the fiber including one or more polarization filters to permit an emitted radiation intensity to be varied.

The Faraday effect is a phenomenon wherein a plane of polarization of linearly polarized light rotates when the light is propagated through a transparent medium placed in a magnetic field and in parallel with the magnetic field. An effectiveness of the magnitude of polarization rotation varies with the strength of the magnetic field, the Verdet constant inherent to the medium and the light path length. The empirical angle of rotation is given by

$$β = VBd$$

(Eq. 1)

where V is called the Verdet constant (and has units of arc minutes cm-1 Gauss-1), B is the magnetic field and d is the propagation distance subject to the field. In the quantum mechanical description, Faraday rotation occurs because imposition of a magnetic field alters the energy levels.

It is known to use discrete materials (e.g., iron-containing garnet crystals) having a high Verdet constant for measurement of magnetic fields (such as those caused by electric current as a way of evaluating the strength of the current) or as a Faraday rotator used in an optical isolator. An optical isolator includes a Faraday rotator to rotate by 45° the plane of polarization, a magnet for application of magnetic field, a polarizer, and an analyzer. Conventional optical isolators have been of the bulk type wherein no fiber is used.

In conventional optics, magneto-optical modulators have been produced from paramagnetic and ferromagnetic materials, particularly garnets (yttrium/iron garnet for example). Devices such as these require considerable magnetic control fields. The magneto-optical effects are also used in thin-layer technology, particularly for producing non-reciprocal devices, such as non-reciprocal junctions. Devices such as these are based on a conversion of modes by Faraday effect or by Cotton-Moutton effect.

A further drawback to using paramagnetic and ferromagnetic materials in magneto-optic devices is that these materials may adversely affect properties of the radiation other than polarization angle, such as for example amplitude, phase, and/or frequency.

There is a need for a modulating waveguide structure for transmitting radiation having one or more predetermined properties, with the modulating waveguide structure having a mechanism for controllably influencing the one or more predetermined properties to vary an intensity of emitted radiation.

### BRIEF SUMMARY OF THE INVENTION

Disclosed is an apparatus and method for modulating radiation having one or more predetermined properties, the apparatus and method including a waveguide structure having a mechanism for controllably influencing the one or more predetermined properties to modulate an emitted intensity. A radiation wave intensity modulator includes a first element for producing a wave component from a radiation wave, the wave component having a polarization property wherein the polarization property is selected from one of an orthogonal set of polarizations; an optical transport for receiving the wave component; a transport influencer, operatively coupled to the optical transport, for affecting the polarization property of the wave component responsive to a control signal; and a second element for interacting with the affected wave component wherein an intensity of the wave component is varied responsive to the control signal. A radiation wave intensity modulating method, the method includes producing a wave component from a radiation wave, the wave component having a polarization property wherein the polarization property is selected from one of an orthogonal set of polarizations (e.g., one of a right hand circular polarization or a left hand circular polarization); receiving the wave component; affecting the polarization property of the wave component responsive to a control signal; and interacting with the affected wave component wherein an intensity of the wave component is varied responsive to the control signal.

The apparatus and method of the present invention provide the well-known advantages of a modulating waveguide in transmitting radiation while efficiently controlling selected properties of the transmitted radiation to vary an output intensity. In a preferred embodiment, the waveguide is an optical transport adapted to enhance the property influencing characteristics of the influencer while preserving desired attributes of the radiation and includes (as discrete components or integrated components polarizing elements to interact with the radiation). In a preferred embodiment, the property of the radiation to be influenced includes a polarization state of the radiation and the influencer uses a Faraday effect to control a polarization rotation angle using a controllable, variable magnetic field propagated parallel to a transmission axis of the optical transport. The optical transport is constructed to enable the polarization to be controlled quickly using low magnetic field strength over very short optical paths. Radiation is initially controlled to produce a wave component have one particular polarization; the polarization of that wave component is influenced so that a second polarizing filter modulates an emitted radiation intensity in response to the influencing effect. In the preferred embodiment, this modulation includes extinguishing the emitted radiation.

The invention provides for a modulating waveguide structure for transmitting radiation having one or more predetermined properties, with the modulating waveguide structure having a mechanism for controllably influencing the one or more predetermined properties to vary an intensity of emitted radiation

### BRIEF DESCRIPTION OF THE DRAWINGS

Fig_1 is a general schematic plan view of a preferred embodiment of the present invention;

Fig_2 is a detailed schematic plan view of a specific implementation of the preferred embodiment shown in Fig_1; and

Fig_3 is an end view of the preferred embodiment shown in Fig_2.

### DETAILED DESCRIPTION OF THE INVENTION

The present invention relates to a modulating waveguide structure for transmitting radiation having one or more predetermined properties, with the modulating waveguide structure having a mechanism for controllably influencing the one or more predetermined properties to vary an intensity of emitted radiation. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the following description, three terms have particular meaning in the context of the present invention: (1) optical transport, (2) property influencer, and (3) extinguishing. For purposes of the present invention, an optical transport is a waveguide particularly adapted to enhance the property influencing characteristics of the influencer while preserving desired attributes of the radiation. In a preferred embodiment, the property of the radiation to be influenced includes its polarization rotation state and the influencer uses a Faraday effect to control the polarization angle using a controllable, variable magnetic field propagated parallel to a transmission axis of the optical transport. The optical transport is constructed to enable the polarization to be controlled quickly using low magnetic field strength over very short optical paths. In such particular implementations, the optical transport includes optical fibers exhibiting high Verdet constants for the wavelengths of the transmitted radiation while concurrently preserving the waveguiding attributes of the fiber and otherwise providing for efficient construction of, and cooperative affectation of the radiation property(ies), by the property influencer.

The property influencer is a structure for implementing the property control of the radiation transmitted by the optical transport. In the preferred embodiment, the property influencer is operatively coupled to the optical transport, which in one implementation for an optical transport formed by an optical fiber having a core and one or more cladding layers, preferably the influencer is integrated into or on one or more of the cladding layers without significantly adversely altering the waveguiding attributes of the optical transport. In the preferred embodiment using the polarization property of transmitted radiation, the preferred implementation of the property influencer is a polarization influencing structure, such as a coil, coilform, or other integratable structure that manifests a Faraday effect in the optical transport (and thus on the transmitted radiation) using one or more magnetic fields (one or more of which are controllable).

The structured waveguide of the present invention serves to modulate an intensity of radiation transmitted by the optical transport. The radiation emitted by the modulator will have a maximum radiation intensity and a minimum radiation intensity, controlled by the interaction of the property influencer on the optical transport. Extinguishing simply refers to the minimum radiation intensity being at a sufficiently low level (as appropriate for the particular embodiment) to be characterized as "off" or "dark" or other classification indicating an absence of radiation. In other words, in some applications a sufficiently low but detectable/discernable radiation intensity may properly be identified as "extinguished" when that level meets the parameters for the implementation or embodiment.

Fig_1 is a general schematic plan view of a preferred embodiment of the present invention for a Faraday structured waveguide modulator 100. Modulator 100 includes an optical transport 105, a property influencer 110 operatively coupled to transport 105, a first property element 120, and a second property element 125.

Transport 105 may be implemented based upon many well-known optical waveguide structures of the art. For example, transport 105 may be a specially adapted optical fiber having a core and one or more cladding layers, or transport 105 may be a waveguide channel of a bulk device or substrate. The conventional waveguide structure is modified based upon the type of radiation property to be influenced and the nature of influencer 110.

Influencer 110 is a structure for manifesting property influence on the radiation transmitted through transport 105 and/or on transport 105. Many different types of radiation properties may be influenced, and in many cases a particular structure used for influencing any given property may vary from implementation to implementation. In the preferred embodiment, properties that may be used in turn to control an output intensity of the radiation are desirable properties for influence. For example, radiation polarization angle is one property that may be influenced and is a property that may be used to control a transmitted intensity of the radiation. Use of another element, such as a fixed polarizer will control radiation intensity based upon the polarization angle of the radiation compared to the transmission axis of the polarizer. Controlling the polarization angle varies the transmitted radiation in this example.

However, it is understood that other types of properties may be influenced as well and may be used to control output intensity, such as for example, radiation phase or radiation frequency. Typically, other elements are used with modulator 100 to control output intensity based upon the nature of the property and the type and degree of the influence on the property. In some embodiments another characteristic of the radiation may be desirably controlled rather than output intensity, which may require that a radiation property other than those identified be controlled, or that the property may need to be controlled differently to achieve the desired control over the desired attribute.

A Faraday effect is but one example of one way of achieving polarization control within transport 105. A preferred embodiment of influencer 110 for Faraday polarization rotation influence uses a combination of variable and fixed magnetic fields proximate to or integrated within/on transport 105. These magnetic fields are desirably generated so that a controlling magnetic field is oriented parallel to a propagation direction of radiation transmitted through transport 105. Properly controlling the direction and magnitude of the magnetic field achieves a desired degree of influence on the radiation polarization angle.

It is preferable in this particular example that transport 105 be constructed to improve/maximize the "influencibility" of the selected property by influencer 110. For the polarization rotation property using a Faraday effect, transport 105 is doped, formed, processed, and/or treated to increase/maximize the Verdet constant. The greater the Verdet constant, the easier influencer 110 is able to influence the polarization rotation angle at a given field strength and transport length. In the preferred embodiment of this implementation, attention to the Verdet constant is the primary task with other features/attributes/characteristics of the waveguide aspect of transport 105 secondary. In the preferred embodiment, influencer 110 is integrated or otherwise "strongly associated" with transport 105, though some implementations may provide otherwise.

Element 120 and element 125 are property elements for selecting/filtering/operating on the desired radiation property to be influenced by influencer 110. Element 120 may be a filter to be used as a "gating" element to pass wave components of the input radiation having a desired state for the appropriate property, or it may be a "processing" element to conform one or more wave components of the input radiation to a desired state for the appropriate property. The gated/processed wave components from element are provided to optical transport 105 and property influencer 110 controllably influences the transported wave components as described above.

Element 125 is a cooperative structure to element 120 and operates on the influenced wave components. Element 125 is a structure that emits WAVE_OUT and controls an intensity of WAVE_OUT based upon a state of the property of the wave component. The nature and particulars of that control relate to the influenced property and the state of the property from element 120 and the specifics of how that initial state has been influenced by influencer 110.

For example, when the property to be influenced is a polarization property/polarization rotation angle of the wave components, element 120 and element 125 may be polarization filters. Element 120 selects one specific type of polarization for the wave component, for example right hand circular polarization. Influencer 110 controls a polarization rotation angle of radiation as it passes through transport 105. Element 125 filters the influenced wave component based upon the final polarization rotation angle as compared to a transmission angle of element 125. In other words, when the polarization rotation angle of the influenced wave component matches the transmission axis of element 125, WAVE_OUT has a high intensity level. When the polarization rotation angle of the influenced wave component is "crossed" with the transmission axis of element 125, WAVE_OUT has a low intensity level. A cross in this context refers to a rotation angle about ninety degrees misaligned with the transmission axis.

Further, it is possible to establish the relative orientations of element 120 and element 125 so that a default condition results in a maximum intensity of WAVE_OUT, a minimum intensity of WAVE_OUT, or some value in between. A default condition refers to a magnitude of the output intensity without influence from influencer 110. For example, by setting the transmission axis of element 125 at a ninety degree relationship to a transmission axis of element 120, the default condition would be a minimum intensity for the preferred embodiment.

Element 120 and element 125 may be discrete components or one or both structures may be integrated onto or into transport 105. In some cases, the elements may be localized at an "input" and an "output" of transport 105 as in the preferred embodiment, while in other embodiments these elements may be distributed in particular regions of transport 105 or throughout transport 105.

In operation, radiation (shown as WAVE_IN) is incident to element 120 and an appropriate property (e.g. a right hand circular polarization (RCP) rotation component) is gated/processed to pass an RCP wave component to transport 105. Transport 105 transmits the RCP wave component until it is interacted with by element 125 and the wave component (shown as WAVE_OUT) is emitted. Incident WAVE_IN typically has multiple orthogonal states to the polarization property (e.g., right hand circular polarization (RCP) and left hand circular polarization (LCP)). Element 120 produces a particular state for the polarization rotation property (e.g., passes one of the orthogonal states and blocks/shifts the other so only one state is passed). Influencer 110, in response to a control signal, influences that particular polarization rotation of the passed wave component and may change it as specified by the control signal. Influencer 110 of the preferred embodiment is able to influence the polarization rotation property over a range of about ninety degrees. Element 125 then interacts with the wave component as it has been influenced permitting the radiation intensity of WAVE_IN to be modulated from a maximum value when the wave component polarization rotation matches the transmission axis of element 125 and a minimum value when the wave component polarization is "crossed" with the transmission axis. By use of element 120, the intensity of WAVE_OUT of the preferred embodiment is variable from a maximum level to an extinguished level.

Fig_2 is a detailed schematic plan view of a specific implementation of the preferred embodiment shown in Fig_1. This implementation is described specifically to simplify the discussion, though the invention is not limited to this particular example. Faraday structured waveguide modulator 100 shown in Fig_1 is a Faraday optical modulator 200 shown in Fig_2.

Modulator 200 includes a core 205, a first cladding layer 210, a second cladding layer 215, a coil or coilform 220 (coil 220 having a first control node 225 and a second control node 230), an input element 235, and an output element 240. Fig_3 is a sectional view of the preferred embodiment shown in Fig_2 taken between element 235 and element 240 with like numerals showing the same or corresponding structures.

Core 205 may contain one or more of the following dopants added by standard fiber manufacturing techniques, e.g., variants on the vacuum deposition method: (a) color dye dopant (makes modulator 200 effectively a color filter alight from a source illumination system), and (b) an optically-active dopant, such as YIG or Tb or TGG or other dopant for increasing the Verdet constant of core 205 to achieve efficient Faraday rotation in the presence of an activating magnetic field. Heating or applying stress to the fiber during manufacturing adds holes or irregularities in core 205 to further increase the Verdet constant and/or implement non-linear effects.

Much silica optical fiber is manufactured with high levels of dopants relative to the silica percentage (this level may be as high as fifty percent dopants). Current dopant concentrations in silica structures of other kinds of fiber achieve about ninety-degree rotation in a distance of tens of microns. Conventional fiber manufacturers continue to achieve improvements in increasing dopant concentration (e.g., fibers commercially available from JDS Uniphase) and in controlling dopant profile (e.g. fibers commercially available from Corning Incorporated). Core 205 achieves sufficiently high and controlled concentrations of optically active dopants to provide requisite quick rotation with low power in micron-scale distances, with these power/distance values continuing to decrease as further improvements are made.

First cladding layer 210 (optional in the preferred embodiment) is doped with ferro-magnetic single-molecule magnets, which become permanently magnetized when exposed to a strong magnetic field. Magnetization of first cladding layer 210 may take place prior to the addition to core 205 or pre-form, or after modulator 200 (complete with core, cladding, coating(s) and/or elements) is drawn. During this process, either the preform or the drawn fiber passes through a strong permanent magnet field ninety degrees offset from a transmission axis of core 205. In the preferred embodiment, this magnetization is achieved by an electro-magnetic disposed as an element of a fiber pulling apparatus. First cladding layer 210 (with permanent magnetic properties) is provided to saturate the magnetic domains of the optically-active core 205, but does not change the angle of rotation of the radiation passing through fiber 200, since the direction of the magnetic field from layer 210 is at right-angles to the direction of propagation. The incorporated provisional application describes a method to optimize an orientation of a doped ferromagnetic cladding by pulverization of non-optimal nuclei in a crystalline structure.

As single-molecule magnets (SMMs) are discovered that may be magnetized at relative high temperatures, the use of these SMMs will be preferable as dopants. The use of these SMMs allow for production of superior doping concentrations and dopant profile control. Examples of commercially available single-molecule magnets and methods are available from ZettaCore, Inc. of Denver, Colorado.

Second cladding layer 215 is doped with a ferrimagnetic or ferromagnetic material and is characterized by an appropriate hysteresis curve. The preferred embodiment uses a "short" curve that is also "wide" and "flat," when generating the requisite field. When second cladding layer 215 is saturated by a magnetic field generated by an adjacent field-generating element (e.g. coil 220), itself driven by a signal (e.g., a control pulse) from a controller such as a switching matrix drive circuit (not shown), second cladding layer 215 quickly reaches a degree of magnetization appropriate to the degree of rotation desired for modulator 200. Further, second cladding layer 215 remains magnetized at or sufficiently near that level until a subsequent pulse either increases (current in the same direction), refreshes (no current or a +/- maintenance current), or reduces (current in the opposite direction) the magnetization level. This remanent flux of doped second cladding layer 215 maintains an appropriate degree of rotation over time without constant application of a field by influencer 110 (e.g., coil 220).

Appropriate modification/optimization of the doped ferri/ferromagnetic material may be further effected by ionic bombardment of the cladding at an appropriate process step. Reference is made to US Patent No. 6,103,010 entitled "METHOD OF DEPOSITING A FERROMAGNETIC FILM ON A WAVEGUIDE AND A MAGNETO-OPTIC COMPONENT COMPRISING A THIN FERROMAGNETIC FILM DEPOSITED BY THE METHOD" and assigned to Alcatel of Paris, France in which ferromagnetic thin-films deposited by vapor-phase methods on a waveguide are bombarded by ionic beams at an angle of incidence that pulverizes nuclei not ordered in a preferred crystalline structure. Alteration of crystalline structure is a method known to the art, and may be employed on a doped silica cladding, either in a fabricated fiber or on a doped preform material. The ‘010 patent is hereby expressly incorporated by reference for all purposes.

Similar to first cladding layer 210, suitable single-molecule magnets (SMMs) that are developed and which may be magnetized at relative high temperatures will be preferable as dopants in the preferred embodiment for second cladding layer 215 to allow for superior doping concentrations.

Coil 220 of the preferred embodiment is fabricated integrally on or in fiber 200 to generate an initial magnetic field. This magnetic field from coil 220 rotates the angle of polarization of radiation transmitted through core 205 and magnetizes the ferri/ferromagnetic dopant in second cladding layer 215. A combination of these magnetic fields maintains the desired angle of rotation for a desired period (such a time of a video frame when a matrix of fibers 200 collectively form a display as described in one of the related patent applications incorporated herein). For purposes of the present discussion, a "coilform" is defined as a structure similar to a coil in that a plurality of conductive segments are disposed parallel to each other and at right-angles to the axis of the fiber. As materials performance improves - that is, as the effective Verdet constant of a doped core increases by virtue of dopants of higher Verdet constant (or as augmented structural modifications, including those introducing non-linear effects) - the need for a coil or "coilform" surrounding the fiber element may be reduced or obviated, and simpler single bands or Gaussian cylinder structures will be practical. These structures, when serving the functions of the coilform described herein, are also included within the definition of coilform

When considering the variables of the equation specifying the Faraday effect: field strength, distance over which the field is applied, and the Verdet constant of the rotating medium, one consequence is that structures, components, and/or devices using modulator 200 are able to compensate for a coil or coilform formed of materials that produce less intense magnetic fields. Compensation may be achieved by making modulator 200 longer, or by further increasing/improving the effective Verdet constant. For example, in some implementations, coil 220 uses a conductive material that is a conductive polymer that is less efficient than a metal wire. In other implementations, coil 220 uses wider but fewer windings than otherwise would be used with a more efficient material. In still other instances, such as when coil 220 is fabricated by a convenient process but produces coil 220 having a less efficient operation, other parameters compensate as necessary to achieve suitable overall operation.

This recognizes that there are tradeoffs between design parameters -fiber length, Verdet constant of core, and peak field output and efficiency of the field-generating element. Taking these tradeoffs into consideration produces four preferred embodiments of an integrally-formed coilform, including: (1) twisted fiber to implement a coil/coilform, (2) fiber wrapped epitaxially with a thinfilm printed with conductive patterns to achieve multiple layers of windings, (3) printed by dip-pen nanolithography on fiber to fabricate a coil/coilform, and (4) coil/coilform wound with coated/doped glass fiber, or alternatively a conductive polymer that is metallically coated or uncoated, or a metallic wire. Further details of these embodiments are described in the related and incorporated provisional patent application referenced above.

Node 225 and node 230 receive a signal for inducing generation of the requisite magnetic fields in core 205, cladding layer 215, and coil 220. This signal in a simple embodiment is a DC (direct current) signal of the appropriate magnitude and duration to create the desired magnetic fields and rotate the polarization angle of the WAVE_IN radiation propagating through modulator 200. A controller (not shown) may provide this control signal when modulator 200 is used.

Input element 235 and output element 240 are polarization filters in the preferred embodiment, provided as discrete components or integrated into/onto core 205. Input element 235, as a polarizer, may be implemented in many different ways. Various polarization mechanisms may be employed that permit passage of light of a single polarization type (specific circular or linear) into core 205; the preferred embodiment uses a thin-film deposited epitaxially on an "input" end of core 205. An alternate preferred embodiment uses commercially available nano-scale microstructuring techniques on waveguide 200 to achieve polarization filtering (such as modification to silica in core 205 or a cladding layer as described in the incorporated Provisional Patent Application.) In some implementations for efficient input of light from one or more light source(s), a preferred illumination system may include a cavity to allow repeated reflection of light of the "wrong" initial polarization; thereby all light ultimately resolves into the admitted or "right" polarization. Optionally, especially depending on the distance from the illumination source to modulator 200, polarization-maintaining waveguides (fibers, semiconductor) may be employed.

Output element 240 of the preferred embodiment is a "polarization filter" element that is ninety degrees offset from the orientation of input element 235 for a default "off" modulator 200. (In some embodiments, the default may be made "on" by aligning the axes of the input and output elements. Similarly, other defaults such as fifty percent intensity may be implemented by appropriate relationship of the input and output elements and suitable control from the influencer.) Element 240 is preferably a thin-film deposited epitaxially on an output end of core 205. Input element 235 and output element 240 may be configured differently than described here using other polarization filter/control systems. When the radiation property to be influenced includes a property other than a radiation polarization angle (e.g., phase or frequency), other input and output functions are used to properly gate/process/filter the desired property as described above to modulate the intensity of WAVE_OUT responsive to the influencer.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A "computer-readable medium" for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A "processor" or "process" includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in "real time," "offline," in a "batch mode," etc. Portions of processing can be performed at different times and at different locations, by different (or the same) processing systems.

Reference throughout this specification to "one embodiment", "an embodiment", "a preferred embodiment" or "a specific embodiment" means that a particular feature, structure, or characteristic described in connection with the embodiment is included in at least one embodiment of the present invention and not necessarily in all embodiments. Thus, respective appearances of the phrases "in one embodiment", "in an embodiment", or "in a specific embodiment" in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term "or" as used herein is generally intended to mean "and/or" unless otherwise indicated. Combinations of components or steps will also be considered as being noted, where terminology is foreseen as rendering the ability to separate or combine is unclear.

As used in the description herein and throughout the claims that follow, "a", "an", and "the" includes plural references unless the context clearly dictates otherwise. Also, as used in the description herein and throughout the claims that follow, the meaning of "in" includes "in" and "on" unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A radiation wave intensity modulator, comprising:
a first element for producing a wave component from a radiation wave, said wave component having a polarization property wherein said polarization property is one polarization from a set of orthogonal polarizations;
an optical transport for receiving said wave component, said transport having a waveguiding region and one or more guiding regions coupled to said waveguiding region;
a transport influencer, operatively coupled to said optical transport and having at least a portion integrated with one or more guiding regions of said one or more guiding regions, for affecting said polarization property of said wave component responsive to a control signal; and
a second element for interacting with said affected wave component wherein an intensity of said wave component is varied responsive to said control signal.

2. The modulator of claim 1 wherein said first element and said second element are polarization filters.

3. The modulator of claim 1 wherein said elements are integrated into said transport.

4. The modulator of claim 1 wherein said influencer produces a controllable magnetic field parallel to a propagation direction of said wave through said transport to alter said polarization property.

5. The modulator of claim 1 wherein said influencer alters said polarization property by changing a rotation angle of said wave component in a range from about zero degrees to about ninety degrees.

6. The modulator of claim 1 wherein said transport is a fiber waveguide including a core and a cladding corresponding to one or more guiding regions of said one or more guiding regions and wherein said influencer includes a magnetic material integrated with said cladding.

7. The modulator of claim 6 wherein said magnetic material includes permanent magnetic material.

8. The modulator of claim 6 wherein said magnetic material is selectively magnetized responsive to an electric current.

9. The modulator of claim 6 wherein said magnetic material is integrated into said fiber waveguide.

10. The modulator of claim 5 wherein said elements are circular polarization filters having a crossed transmission orientation.

11. The modulator of claim 5 wherein said elements are circular polarization filters having an aligned transmission orientation.

12. The modulator of claim 1 wherein said wave component may be extinguished.

13. The modulator of claim 1 wherein said set of orthogonal polarization includes right hand circular polarization and left hand circular polarization.

14. A radiation wave intensity modulating method, the method comprising:
producing a wave component from a radiation wave, said wave component having a polarization property wherein said polarization property is one polarization from a set of orthogonal polarizations;
receiving said wave component by a transport having a waveguiding region and one or more guiding regions coupled to said waveguiding region;
affecting said polarization property of said wave component responsive to a control signal using an influencer having at least a portion integrated with one or more guiding regions of said one or more guiding regions; and
interacting with said affected wave component wherein an intensity of said wave component is varied responsive to said control signal.

15. The method of claim 14 wherein said producing step includes use of a first element, wherein said interacting step includes use of a second element, and wherein said first element and said second element are polarization filters.

16. The method of claim 14 wherein said producing step includes use of a first element, wherein said interacting step includes use of a second element, and wherein said elements are integrated into said transport.

17. The method of claim 14 wherein said influencer produces a controllable magnetic field parallel to a propagation direction of said wave through said transport to alter said polarization property.

18. The method of claim 14 wherein said influencer alters said polarization property by changing a rotation angle of said wave component in a range from about zero degrees to about ninety degrees.

19. The method of claim 14 wherein said transport is a fiber waveguide including a core and a cladding corresponding to one or more guiding regions of said one or more guiding regions and wherein said influencer includes a magnetic material integrated with said cladding.

20. The method of claim 19 wherein said magnetic material includes permanent magnetic material.

21. The method of claim 19 wherein said magnetic material is selectively magnetized responsive to an electric current.

22. The method of claim 19 wherein said magnetic material is integrated into said fiber waveguide.

23. The method of claim 18 wherein said producing step includes use of a first element, wherein said interacting step includes use of a second element, and wherein said elements are circular polarization filters having a crossed transmission orientation.

24. The method of claim 18 wherein said producing step includes use of a first element, wherein said interacting step includes use of a second element, and wherein said elements are circular polarization filters having an aligned transmission orientation.

25. The method of claim 14 wherein said wave component may be extinguished.

26. The method of claim 14 wherein said set of orthogonal polarization includes right hand circular polarization and left hand circular polarization.

27. A radiation wave intensity modulating apparatus, comprising:
means for producing a wave component from a radiation wave, said wave component having a polarization property wherein said polarization property is one polarization from a set of orthogonal polarizations;
means for receiving said wave component by a transport having a waveguiding region and one or more guiding regions coupled to said waveguiding region;
means for affecting said polarization property of said wave component responsive to a control signal using an influencer having at least a portion integrated with one or more guiding regions of said one or more guiding regions; and
means for interacting with said affected wave component wherein an intensity of said wave component is varied responsive to said control signal.

28. The apparatus of claim 27 wherein said producing step includes use of a first element, wherein said interacting step includes use of a second element, and wherein said first element and said second element are polarization filters.

29. The apparatus of claim 27 wherein said producing step includes use of a first element, wherein said interacting step includes use of a second element, and wherein said elements are integrated into said transport.

30. The apparatus of claim 27 wherein said influencer produces a controllable magnetic field parallel to a propagation direction of said wave through said transport to alter said polarization property.

31. The apparatus of claim 27 wherein said influencer alters said polarization property by changing a rotation angle of said wave component in a range from about zero degrees to about ninety degrees.

32. The apparatus of claim 27 wherein said transport is a fiber waveguide including a core and a cladding corresponding to one or more guiding regions of said one or more guiding regions and wherein said influencer includes a magnetic material proximate said cladding.

33. The apparatus of claim 32 wherein said magnetic material includes permanent magnetic material.

34. The apparatus of claim 32 wherein said magnetic material is selectively magnetized responsive to an electric current.

35. The apparatus of claim 32 wherein said magnetic material is integrated into said fiber waveguide.

36. The apparatus of claim 31 wherein said producing step includes use of a first element, wherein said interacting step includes use of a second element, and wherein said elements are circular polarization filters having a crossed transmission orientation.

37. The apparatus of claim 31 wherein said producing step includes use of a first element, wherein said interacting step includes use of a second element, and wherein said elements are circular polarization filters having an aligned transmission orientation.

38. The apparatus of claim 27 wherein said wave component may be extinguished.

39. The apparatus of claim 27 wherein said set of orthogonal polarization includes right hand circular polarization and left hand circular polarization.

40. A radiation wave intensity modulator, comprising:
a first polarizer for producing a wave component from a radiation source, said wave component having a polarization property wherein said polarization property is one polarization from a set of orthogonal polarizations;
a fiber waveguide for receiving said wave component, said waveguide having a core and one or more guiding regions disposed around said core;
a variable magnetic field generating structure, at least of portion of which is integrated with and operatively coupled to one or more of said one or more guiding regions, for affecting said polarization property of said wave component in said core responsive to a control signal; and
a second polarizer for interacting with said affected wave component wherein an intensity of said wave component is varied responsive to said control signal.

41. A computer program product comprising a computer readable medium carrying program instructions for modulation a radiation wave intensity when executed using a computing system, the executed program instructions executing a method, the method comprising:
producing a wave component from a radiation wave, said wave component having a polarization property wherein said polarization property is one polarization from a set of orthogonal polarizations;
receiving said wave component by a transport having a waveguiding region and one or more guiding regions coupled to said waveguiding region;
affecting said polarization property of said wave component responsive to a control signal using an influencer having at least a portion integrated with one or more guiding regions of said one or more guiding regions; and
interacting with said affected wave component wherein an intensity of said wave component is varied responsive to said control signal.

42. The computer program product of claim 41 wherein said producing step includes use of a first element, wherein said interacting step includes use of a second element, and wherein said first element and said second element are polarization filters.

43. The computer program product of claim 41 wherein said producing step includes use of a first element, wherein said interacting step includes use of a second element, and wherein said elements are integrated into said transport.

44. The computer program product of claim 41 wherein said influencer produces a controllable magnetic field parallel to a propagation direction of said wave through said transport to alter said polarization property.

45. The computer program product of claim 41 wherein said influencer alters said polarization property by changing a rotation angle of said wave component in a range from about zero degrees to about ninety degrees.

46. The computer program product of claim 41 wherein said transport is a fiber waveguide including a core and a cladding corresponding to one or more guiding regions of said one or more guiding regions and wherein said influencer includes a magnetic material integrated with said cladding.

47. The computer program product of claim 46 wherein said magnetic material includes permanent magnetic material.

48. The computer program product of claim 46 wherein said magnetic material is selectively magnetized responsive to an electric current.

49. The computer program product of claim 46 wherein said magnetic material is integrated into said fiber waveguide.

50. The computer program product of claim 45 wherein said producing step includes use of a first element, wherein said interacting step includes use of a second element, and wherein said elements are circular polarization filters having a crossed transmission orientation.

51. The computer program product of claim 45 wherein said producing step includes use of a first element, wherein said interacting step includes use of a second element, and wherein said elements are circular polarization filters having an aligned transmission orientation.

52. The computer program product of claim 41 wherein said wave component may be extinguished.

53. The computer program product of claim 41 wherein said set of orthogonal polarization includes right hand circular polarization and left hand circular polarization.

54. A propagated signal on which is carried computer-executable instructions which when executed by a computing system performs a method, the method comprising:
producing a wave component from a radiation wave, said wave component having a polarization property wherein said polarization property is one polarization from a set of orthogonal polarizations;
receiving said wave component by a transport having a waveguiding region and one or more guiding regions coupled to said waveguiding region;
affecting said polarization property of said wave component responsive to a control signal using an influencer having at least a portion integrated with one or more guiding regions of said one or more guiding regions; and
interacting with said affected wave component wherein an intensity of said wave component is varied responsive to said control signal.

55. The signal of claim 54 wherein said producing step includes use of a first element, wherein said interacting step includes use of a second element, and wherein said first element and said second element are polarization filters.

56. The signal of claim 54 wherein said producing step includes use of a first element, wherein said interacting step includes use of a second element, and wherein said elements are integrated into said transport.

57. The signal of claim 54 wherein said influencer produces a controllable magnetic field parallel to a propagation direction of said wave through said transport to alter said polarization property.

58. The signal of claim 54 wherein said influencer alters said polarization property by changing a rotation angle of said wave component in a range from about zero degrees to about ninety degrees.

59. The signal of claim 54 wherein said transport is a fiber waveguide including a core and a cladding corresponding to one or more guiding regions of said one or more guiding regions and wherein said influencer includes a magnetic material integrated with said cladding.

60. The signal of claim 59 wherein said magnetic material includes permanent magnetic material.

61. The signal of claim 59 wherein said magnetic material is selectively magnetized responsive to an electric current.

62. The signal of claim 59 wherein said magnetic material is integrated into said fiber waveguide.

63. The signal of claim 58 wherein said producing step includes use of a first element, wherein said interacting step includes use of a second element, and wherein said elements are circular polarization filters having a crossed transmission orientation.

64. The signal of claim 58 wherein said producing step includes use of a first element, wherein said interacting step includes use of a second element, and wherein said elements are circular polarization filters having an aligned transmission orientation.

65. The signal of claim 54 wherein said wave component may be extinguished.

66. The signal of claim 54 wherein said set of orthogonal polarization includes right hand circular polarization and left hand circular polarization.
